(19) United States
(12) Patent Application Publication
(10) Pub. No.: US 2008/0211380 A1
(43) Pub. Date: Sep. 4, 2008

(54) Scanning Field Emission Display

(76) Inventors: Ho Seob Kim, Chonan-si (KR); Byeng Jin Kim, Incheon (KR)

Correspondence Address: PARK LAW FIRM, 3255 WILSHIRE BLVD, SUITE 1110, LOS ANGELES, CA, 90010, US

(21) Appl. No.: 11/573,612

(22) PCT Filed: Aug. 11, 2005
(86) PCT No.: PCT/KR2005/002598

§ 371 Date: Feb. 12, 2007

(30) Foreign Application Priority Data
Aug. 11, 2004 (KR) 1020040063303

(51) Int. Cl. H01J 1/62

(52) U.S. Cl. 313/495

(57) ABSTRACT

Provided is a scanning field emission display (SFED). The SFED includes an electron emitter and a module for inducing electron emission of the electron emitter and deflecting an electron beam. A multi-SFED may be realized as a large-sized thin and flat display by arranging in an n×m array.

### TECHNICAL FIELD

The present invention relates to a scanning field emission display (SFED) and a multi-SFED, and more particularly to an SFED or micro CRT having a basic structure of a field emission display (FED) and scanning a predetermined domain like a CRT (Cathode Ray Tube).

### BACKGROUND ART

CRT is basically configured of an electron gun, a deflecting yoke (or deflector) and a fluorescent screen, in which images are produced when an electron beam emitted from the electron gun is scanned on the fluorescent screen by the deflecting yoke. However, CRT dominating the display market gradually hands over its position to flat panel displays (FPDs). This is mainly responsible for the weakness of thickness, weight etc. although it is excellent in size of a screen, response speed, brightness, viewing angle, color expression etc. as compared with other displays. Thus, as the screen size increases, CRT remarkably increases in thickness and weight compared to other displays. As a result, CRT fails to meet a tendency toward the large-size screen, and undergoes a rapid drop in market share.

FEDs are devices developed to overcome the limitations of CRT, which is basically configured of an electron emitter for field electron emission, electrodes, and so on. FED is composed of a field emission electron gun per pixel in contrast to the single electron gun of CRT. However, Arrayed field emission electron guns structurally have a problem in uniformity.

### DISCLOSURE OF INVENTION

### Technical Problem

It is an objective of the present invention to provide a thin and flat panel display, capable of solving the problems of conventional CRT and FED.

It is another objective of the present invention to provide a thin and flat type large-area display that is driven at a low voltage using an SFED and is low in power consumption.

### Technical Solution

In an exemplary embodiment of the present invention, there is provided an SFED which includes an electron emitter and a module for accelerating and deflecting electrons emitted from the electron emitter.

In another exemplary embodiment of the present invention, there is provided a display which includes a multi-SFED having unit SFEDs arranged in an n×m matrix, and a screen having a fluorescent section on which images are produced by an electron beam emitted from the SFED.

The SFED according to the present invention has a structure of deflecting the electron beam like a conventional CRT in addition to a basic structure of an FED. This structure is to apply previously developed micro-column technology. (See [1] H. S. Kim, D. W. Kim, S. J. Ahn, Y. C. Kim, S. S. Park, S. K. Choi, and D. Y. Kim, J. Korean Phys. Soc., 43(5), 831, (2003), [2] E. Kratschmer, H. S. Kim, M. G. R Thomson, K. Y. Lee, S. A. Rishton, M. L. Yu, S. Zolgharnain, B. W. Hussey, and T. H. P. Chang, J. Vac. Sci. Techno. B14(6), 3792 (1996), and [3] T. H. P. Chang, M. G. R Thomson, E. Kratschmer, H. S. Kim, M. L. Yu, K. Y. Lee, S. A. Rishton, and B. W. Hussey, J. Vac. Sci. Techno. B14(6), 3774 (1996)). A micro-column is composed of an electron emitter for emitting electrons, a source lens with three electrodes for controlling an electron beam and filtering a part of the beam, two pairs of eight-pole deflectors for scanning the electron beam, and an Einzel or focusing lens for focusing the electron beam. In a micro-column, this structure is a basic structure for a scanning electron microscope and lithography. The micro-column can be produced within 3.5 mm, which is a total length from the electron emitter to the last electrode of the focusing lens. The miniaturized column can maximize a beam current and minimize various aberrations of the lens compared to a conventional column, thus enhancing resolution. Further, due to the electron beam emitted at a low voltage of 1 to 2 kV, the column has a characteristic capable of solving problems caused by use of a conventional high voltage (10 kV or more), such as space charging, electron-electron scattering etc. The micro-column can be fabricated by using a silicon or metal membrane by means of a previously developed semiconductor micromachining technique such as MEMS (Micro-Electro-Mechanical Systems). Thus, the column having lens parts including electrode hole (or aperture) which are precisely manufactured and arranged exactly by the semiconductor process can minimizes optical aberrations to have excellent performance.

The SFED of the present invention is configured of a module which includes an electron gun and a part of a deflector in the micro-column structure, and its power consumption is low by driving at a low-voltage while having the same function as the conventional CRT. Further, it could realize a large-area display by arranging unit SFEDs scanning a small domain in parallel.

### Advantageous Effects

The multi-SFED according to the present invention overcomes disadvantages of the conventional CRT and FED and takes their advantages, which can realize a thin and flat type display that provides low-voltage driving capability to perform scanning with low power consumption.

### BRIEF DESCRIPTION OF THE DRAWINGS

FIG. 1 is a cross-sectional view showing a basic structure of a unit SFED according to the present invention.

FIG. 2 is a conceptual view of a multi-SFED according to the present invention.

FIG. 3 is a plan view showing a control layer for integrally controlling electron beams of a multi-SFED according to the present invention.

FIG. 4 is a plan view showing a control layer for individually controlling electron beams of a multi-SFED according to the present invention.

FIG. 5 is a plan view showing a deflector for deflecting electron beams of a multi-SFED according to the present invention.

FIG. 6 is a perspective view showing an electron emitter layer of a multi-SFED according to the present invention.

FIG. 7 is a schematic perspective view showing a part of a composite multi-SFED according to the present invention.

### BEST MODE FOR CARRYING OUT THE INVENTION

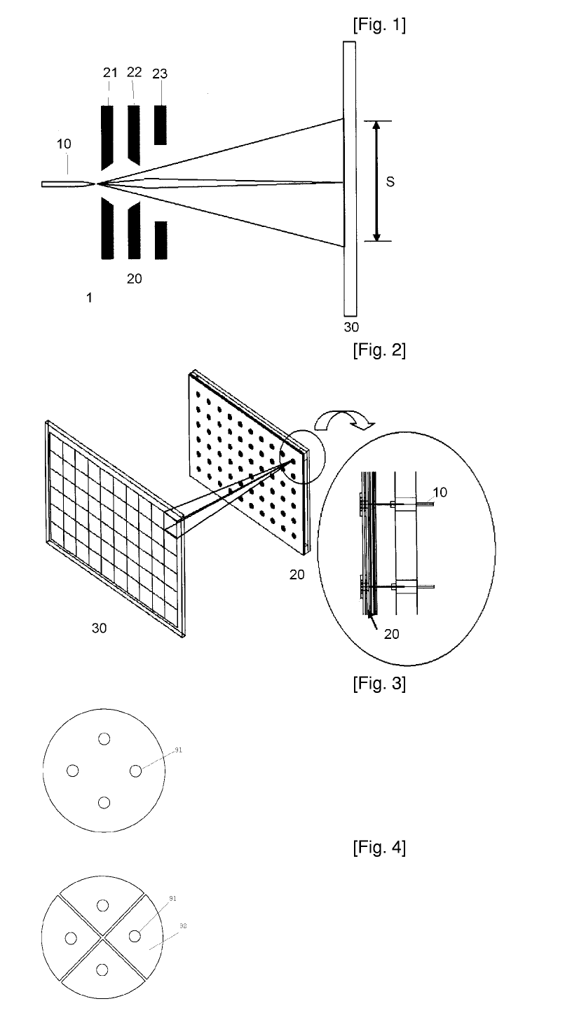

Hereinafter, a general scanning field emission display (SFED) according to the present invention will be described in detail with reference to FIG. 1. A unit SFED 1 of the present invention which electron beam scanning is possible has a basic structure of an electron emitting source 10 for emitting electrons and an SFED module 20 having an extractor 21 for extracting electron emission beam from the emitter, a control electrode 22 for accelerating and focusing the electron beam and a deflector electrode 23 for scanning the electron beam. The distance between the electron emitting source 10 and the extractor 21 is a range from tens to hundreds of micrometers. The SFED is very sensitively operated depending on characteristics of the electron emitting source 10. More particularly, the SFED are composed of the electron emitting tip 10 which is fabricated by chemically etching a tungsten wire, a source lens having the extractor 21 and control electrode 22 that bond an insulating layer, Pyrex, between two layers of Si membranes fabricated by an MEMS process, and the deflecting control electrode 23 for scanning the beam.

The unit SFED has a thin structure where the total length from an end of the electron emitting source to an end of the deflecting control electrode has a range from several microns to several millimeters, and is driven at a low voltage (100V to 1 KV). A display screen 30 having a fluorescent plate is positioned at a predetermined distance from the deflecting control electrode.

In the case of the extractor that stimulates electron emission of the module, control electrode and deflecting control electrode, a high-doped silicon material is used as an electrode, and an insulator such as Pyrex or ceramics is insulated between each layer. In the unit SFED, each silicon electrode has a size of about 10×10 mm (or may be reduced into a size of about 1×1 mm), and a circular or quadrilateral middle aperture having a diameter of tens to hundreds of micrometers, and is elaborately fabricated using a semiconductor or MEMS process such as photolithography, wet etching or dry etching.

Arrangement of the apertures is a very important factor, which has influence on optical aberrations. This arrangement is disclosed in Korean Patent Application No. 10-2001-0040196 titled “AN EXTRACTOR FOR AN MICROCOLUMN AND AN ALIGNMENT METHOD OF AN EXTRACTOR APERTURE AND AN ELECTRON EMITTER” and No. 10-2002-0087224 titled “A MEASURING SYSTEM USING AN ELECTRON BEAM AND A MEASURING METHOD AND AN ALIGNMENT METHOD USING THEREOF”, whose contents are incorporated herein by reference. In these specifications, electron beam emitting source and lenses are arranged in two ways: one by using a diffraction pattern of a laser and the other by measuring a quantity of emitted electrons, which can be applied to the SFED of the present invention. Each electrode hole is arranged by the arrangement method using the laser diffraction pattern, and then bonded by anodic bonding. To sum up the laser arrangement method, when He—Ne laser is vertically fixed to a lower end of an x-y stage and then a laser beam passes through a first electrode hole, the beam passing through the hole forms a diffraction pattern. When the diffraction pattern forms a complete circle, the laser beam and the electrode hole of the lens are positioned on the same optical axis. The diffraction pattern is varied according to the arrangement of two electrode holes. When a second electrode hole is fixed to an x-y-z stage and the two electrode holes are exactly arranged, symmetrical diffraction patterns are formed. When the electrodes are arranged in the laser pattern mode, an SFED module is completed using Nd-YAG laser bonding and anodic bonding. Each electrode of the unit SFED module may be processed to a wafer scale. This type may be preferably applied to multi-structure arrangement. In the multi-structure arrangement, the SFED module can be fabricated even by arrangement of holes in wafer arrangement stacking method using a semiconductor fabricating process.

A range of the electron which passes through the electron emitting source and electrodes to be scanned by one deflector in the unit SFED structure can be defined as follows. Energy of the electron incident onto the deflector is given as E=½ mv²=qVₜᵢₚ where m and q are the mass and charge quantity of the electron respectively, and Vₜᵢₚ is the voltage applied to the tip. A velocity of the electron calculated from this equation is given as

v=\sqrt{2qVₜᵢₚ/m}

The electron is deflected by a voltage V_{D} applied to the deflector when passing through the deflector. At this time, an acceleration of the electron is expressed by α=qEₗ/m. Here, since it is assumed that intensity of an electric field in a deflector region is constantly applied by Eₗ=2V_{D}/D,D is a diameter of the deflector. A distance at which the electron is deflected on the screen by the deflector is expressed by L∝V_{D}T_{d}S/DVₜᵢₚ, where T_{D} is the thickness of the deflector, and S is the distance between the deflector and the screen. Thus, the scanning domain of the unit SFED is proportional to the voltage applied to the deflector and the distance between the deflector and the screen.

FIG. 2 is a conceptual view showing an arrangement structure of a multi-SFED according to the present invention. A large-area multi-SFED has an arrangement structure similar to a conventional FED, but a unit module has a structure scanning a predetermined domain of a fluorescent panel. Therefore, a large-size fluorescent panel 30 of a flat panel type is divided into unit screens of a predetermined size, as in FIG. 2. Unit SFEDs are arranged in an n x m array type to correspond to the unit screens, respectively. With this configuration, a distance between an electron beam source (SFED) and the unit screens can be minimized up to a range from about 50 to 100 mm as in the unit SFED. Further, the unit SFEDs are arranged in parallel to be an array type, so that the array screens can be expanded as he/her pleases to thereby be utilized as a large-size thin and flat display.

The electron emitting source, as a main constituent of the SFED according to the present invention, may use either a thermal emitter (TE) type electron emitting source where an electron emitting source used in the conventional CRT generates electrons from a tungsten filament that is heated (at a temperature of 2000 K or more) by causing a current to flow through the tungsten filament, or a general electron emitting source used in the micro-column. As one example, the electron emitting source of the present invention is a cold field emitter (CFE) having a sharp-pointed tip like the electron emitting source of the micro-column, which can use an electric field electron emission mode where electrons are emitted when a voltage is applied. Here, the tip is machined into a pointed needle by etching a tungsten wire with a KOH or NaOH solution, wherein an end of the pointed needle has a diameter of about hundreds of nm. When the tip is contaminated with impurities or has a rough end, a current discharged from the tip becomes unstable or a rough part is stripped off the tip to damage peripheral electrodes, which acts to hinder operation of the SFED. Thus, in order to improve stability of the current discharged from the tip, a process such as annealing is required. Another method may be used as a general thermal electron emission mode where the pointed needle is heated.

Another electron emitting source may use one from which electrons are emitted, such as a CNT (Carbon-nano-tube) tip, a silicon tip, a tip where a metal is deposited onto silicon, a metal or other machinable tip, a thermal electron (filament) tip, or the like. The CNT tip may be a single CNT tip or a plurality of bundle type CNTs which a re being studied at present.

As described above, an operational principle of the SFED according to the present invention is very similar to that of the micro-column. A positive voltage relative to the electron emitting source is applied to the extractor so as to emit the electrons from the electron emitting source, and a control voltage is applied so as to focus the emitted electron beam. Then, the focused electron beam is deflected and scanned on the fluorescent surface.

### MODE FOR THE INVENTION

A module of an SFED according to the present invention may be variously configured besides combination of an extractor 21, a control electrode 22 and a deflecting control electrode 23 which are configured as the aforementioned basic module. The module of the SFED may be configured to perform clearer and faster scanning by multiple deflecting that is realized by adding a deflector to the afore-mentioned basic module behind the deflecting control electrode.

In addition, a focusing lens may be additionally used for still clearer display like the micro-column, where a unit pixel can be sufficiently reduced in size without high precision focusing like the conventional micro-column. If the high precision focusing is performed, it is possible to make the pixel smaller to perform the scanning. In this case, although a scanning range is equal, the pixel is smaller, so that a time necessary to scan the whole range or a control precision are further required. However, this precise control is possible by use of the control mode of the conventional micro-column. Meanwhile, the size of the pixel is associated with performance of the display, and depends on the human eyesight. Thus, the required unit pixel is formed by using the focusing method of the micro-column if necessary, and thereby the scanning is made possible.

Further, in the case of an advertisement board as a display where a high resolution is not required according to usage of the display or a simple display, the SFED according to the present invention may composed of the electron emitting source for emitting the electron beam and the module only by means of the deflecting lens capable of accelerating and simultaneously deflecting the emitted electron beam. In order words, the simplest SFED is configured by a lens consisting of one layer to simultaneously perform the deflecting and the function of the extractor.

The configuration of the unit SFED according to the present invention is as described above. However, when the unit SFEDs are arranged in the n×m array to form one SFED, various configurations are possible. First of all, each of the unit SFEDs may construct the SFED like each independent single micro-column. All of the unit SFEDs may construct the SFED like one wafer type multi-microcolumn. In addition, as a complex type, the SFED fabricated by mixing the unit single microcolumn and a wafer type of lens layer is possible.

Which configuration is selected to fabricate the SFED is dependent on choice of a user. Here, the wafer type is suitable for mass production. The single type is suitable for small production. The mixed type is suitable for intermediate between the mass production and the small production, and can be selected by the user at needs regardless of the spirit of the present invention.

A method of driving the SFED according to the present invention is to drive unit SFEDs arranged in an n x m array. Here, each of the unit SFEDs may be driven, but be controlled in the same way as the method of controlling the electron beams in the multi-microcolumns. This operation method of the multi-microcolumns is disclosed in Korean Patent Application No. 10-2004-0052102 titled “Method for controlling electron beams in multi-microcolumn and a multi-microcolumn using the same”, in which an operational principle of electron emitting sources and lens layers is incorporated herein by reference. An operational principle of the multi-SFED of the present invention may be performed similar to the above-mentioned operational principle.

Hereinafter, the operational principle of the multi-SFEDs of the present invention will be schematically described based on that described in Korean Patent Application No. 10-2004-0052102.

First, a module will be described with reference to FIGS. 3 to 5.

A control layer (lens layer) shown in FIG. 3 is for four unit modules and has a kind of 2×2 array. The same voltage is applied to the entire layer 90a regardless of each unit constituent (aperture 91). Thus, the entire layer is formed of the same material and is connected by one connection so as to be able to be supplied with a voltage from the outside. In other words, the entire layer is formed of the same material so that, when the voltage is applied to the connection, the same voltage is applied to the entire layer. As the material, a conductor or semiconductor capable of establishing an equivalent potential when applying the voltage is used. This control layer is characterized by applying the same voltage to all the unit modules. As a result, the control layer can be controlled in the simplest manner.

A control layer 90b shown in FIG. 4 is directed to control electron beams by application of a separate voltage to each unit module. That is, a lens section 92 including a lens aperture 91 is etched and insulated from the other surrounding lens sections so that the voltages are individually applied according to a domain of each unit SFED. In order to apply the voltage according to each unit lens, wiring can be carried out through separately divided etched portion (in the case of many unit SFEDs). In this case, each unit lens section 92 may be formed by a method other than etching, but most preferably by etching. This is because attaching and etching a general lens layer to an upper or lower insulating layer from the viewpoint of a process is more rapid and precise than separately attaching segments by bonding or the like.

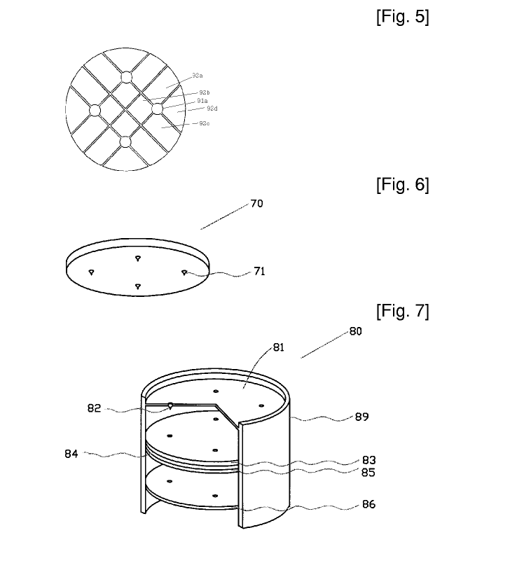

FIG. 5 shows a control layer 90c that can perform deflecting and be used as a deflector. The deflecting control layer is subdivided into unit electrodes 92a, 92b, 92c and 92d on the basis of a unit aperture 91a, and etched and insulated between the unit electrodes. In FIG. 5, the number of unit electrodes is four. Two or more unit electrodes are used, and preferably in symmetry. There may be used eight unit electrodes. Wiring is carried out as in FIG. 4. The wiring can be carried out by using each etched portions, and can be formed by using a pattern or the like on the outside or within the etched portions.

The deflecting may be performed by applying the same voltage according to a direction of each module, or by applying an individual voltage according to a direction of each deflector of each module. This may be differentially applied according to a characteristic of the display.

Describing the control layer on the basis of the module of the above-mentioned basic SFED, an extractor can operate by integral or individual application of the voltage of FIG. 3. A voltage is applied to the extractor according to correlation with an electron emitter. Preferably, the voltage is individually applied to each extractor or each electron emitter according to each module of a unit SFED. In other words, when the voltage is applied according to the module of each unit SFED to control the electron emitter and is compensated, the same voltage may be integrally applied to all the extractors as in FIG. 3. In contrast, when the voltage is integrally applied to the electron emitter of each unit module, the voltage may be individually applied to each unit extractor to control a quantity of emitted electron beam. Of course, the voltage may be individually applied to both the unit electron emitter and the unit extractor to control the quantity of emitted electron beam.

As the control electrode, the integral control electrode of FIG. 3 may be used so that the same voltage is applied to all its apertures in order to control all the electron beams of the multi-SFED. Of course, in this case, the individual control electrode of FIG. 4 may be used for individual control.

In view of the deflector, the voltage is individually applied according to a direction of the unit deflector of each unit SFED to deflect the electron beam, as in FIG. 5. However, with regard to deflecting control of the electron beam, it is simpler to apply the same voltage to the electrodes according to the direction (coordinate) of each unit deflector to allow the electron beam of each unit SFED to be simultaneously deflected in the same direction. This method is good to perform the wiring so as to apply the same voltage according to the direction.

FIG. 6 shows an electron emitter layer that is configured in an integral control type. Alternatively, the electron emitter layer may be configured in an individual control type. In FIG. 6, an example is shown which an electron emitter layer 70 is configured of one wafer layer so that the same voltage is applied. Although the same voltage is applied, actually emitted electron beams may be varied depending on a tip 71 of each electron emitter. This is because the case where the same electron beam is not emitted by various reasons such as a shape of the tip takes place actually. The electron emitter may be a conventional electron emitter such as a tungsten (W) emitter, a schottky emitter, a silicon (Si) emitter, a molybdenum (Mo) emitter, a CNT emitter or the like, which has been generally used. The electron emitters are all adapted to be connected to have the same voltage. Accordingly, in order to make a quantity of electron beam emitted from each electron emitter uniform, a voltage of the extractor must be differentially applied according to each emitter. For this reason, the voltage of the extractor must be applied in a mode similar to that of FIG. 4. As for the extractor, each aperture requires a different voltage but not direction. Thus, one circular electrode has only to be provided around the apertures. Here, the quantity of electron beam emitted from each electron emitter can be checked through a quantity of the electron beam passing through the column, so that a required voltage can be differentially applied to each electron emitter. Thereby, the quantity of electron beam emitted from each electron emitter can be made uniform.

To be more specific about a method for controlling electron beams in a multi-SFED, in which each unit SFED for emitting electrons to form and control the electron beam is arranged in an n×m matrix, the method comprises the steps of:

dividing an individual electron emitter and an individual electron lens into

a type of applying a single voltage to all apertures through which the electrons of the unit SFED part pass or all electron emitters (first type),

a type of applying a voltage to each unit SFED (aperture or electron emitter) (second type),

a type of applying the same voltage to each same-directional (-coordinate) electrode per unit SFED (third type), and

a type of applying a voltage to each unit SFED and electrode (direction or coordinate) (fourth type);

applying a voltage to the individual electron emitter and an individual extractor of the lens according to the first or second type to emit the electrons from the electron emitter in order to induce emission and electron current; and

applying a voltage according to the third or fourth type to deflect the electron beams.

The control layer of FIG. 3 is used for the first type, the control layer of FIG. 4 is used for the second type, and the control layer of FIG. 5 is used for the third and fourth types. In the control layer of FIG. 5, it acts as the third type when the electrodes according to each direction are commonly wired, and it acts as the fourth type when the electrodes according to each direction are individually wired and applied with the voltage. When the voltage is applied according to each direction with the electrode wired individually, the control layer of FIG. 5 can be controlled in the third type. In other words, the third and fourth types can be divided not only by the wiring, but also by direction-specific application of the voltage in the individually wired state.

In the controlling method, focusing may be performed in the first type.

According to this operational principle of the SFED, the deflector may act as the extractor. That is, since it is sufficient to establish a voltage difference according to a coordinate of each unit deflector in order to perform deflecting, emission of the electron beam is induced when applying a voltage required for the deflecting in addition to a voltage required for the extractor. Similarly, in the case of the control electrode for accelerating the electron beam, acceleration of the electron beam is possible when all voltages required for acceleration are applied to each electrode of the deflector, and when coordinate-specific voltage differences for the deflecting are applied.

Thus, the SFED and multi-SFED according to the present invention can be sufficiently realized by forming the module only with the deflectors and by varying only the mode of applying the voltage. In other words, in the case of the basic SFED, only the deflectors could be configured to act as the extractor and the accelerating control electrode, thereby performing function of inducing the emission of the electron beam and of controlling the acceleration of the electron beam in the above-mentioned method. As a result, the module can be realized.

Although schematically described above, it is very important to bond the control electrodes of the module and to arrange the apertures of the control electrodes and the electron emitters. However, when the above wafer type complies with the method of fabricating a semiconductor wafer in the design and fabrication, the entire multi-SFED can be fabricated without separate arranging or bonding.

However, in the case of the SFED of a mixed or an n×m array of simple single types, the bonding of the electrodes and the arrangement of the electrodes and the electron emitters are very important, and the arrangement is preferably performed as mentioned above. In this case, like the mixed type of mixing the wafer type and the single type in Korean Patent Application No. 10-2004-0052102, the multi-SFED of the present invention may be configured in a mixed type of electron emitters and lenses of a wafer type and a wire type deflector of a single type, as in FIG. 7.

As in FIG. 7, a mixed type multi-SFED 80 includes an electron emitter layer having electron emitter tips 82 and fixtures 81 fixing the tips 82 so as to correspond to unit SFEDs; a module having an extractor layer 83, an insulating layer 84 and another control electrode layer 85; and a deflector 86, each of which is disposed on each layer of a wafer type and is fixed to a housing 89 like a conventional single SFED. Of course, in this case, as the electron emitter layer, the electron emitter layer 70 of FIG. 6 may be used. In the case of the mixed type, a constituent of each portion other than the wafer type layer may be inserted and fixed as a composite body of the single SFED within the housing 89 of the entire multi-SFED using a fixable means such as a fixture so as to correspond to the unit SFED, for example, like fixing and using the electron emitter tips 82 to the fixtures 81. In addition, since it is possible to multiply a membrane of the single SFED that is substantially used at present to fabricate the module in the wafer type in advance, the entire multi-SFED can be fabricated by previously setting the housing 89 in which the electron emitter, lens layer and deflector are located and previously forming the lens layer in the wafer type. Further, only the electron emitter and lens layer are formed in the wafer type, and the others is fabricated in a general single SFED type. Then, they are inserted and fixed in the housing 89 using means such as the fixture for the electron emitter. Thereby, the mixed type multi-SFED can be fabricated. That is, in the mixed type, the multi-SFED can be fabricated in very various ways.

A beam blanker layer may be added to the multi-SFED. As described in the controlling method, the beam blanker layer may be added between arbitrary layers, but preferably located in front of the deflector. The beam blanker layer has the same structure as the deflector. In the case of using multiple deflectors, any one may be adapted to act as the beam blanker layer.

Shapes of the electron beams scanned onto the fluorescent section may be varied at needs. To this end, Shapes of the apertures of the lens layer may be varied. In order to specify the shapes of the electron beams in a predetermined shape at needs, a separate lens layer having predetermined shapes of apertures may be added. The separate lens layer having the predetermined shapes of apertures may be positioned before and/or after deflecting.

Further, the multi-SFED according to the present invention can display colors display, which can be easily applied as the same principle as the conventional CRT. Also, current various color display technologies may be easily applied to the multi-SFED according to the present invention. For example, three unit SFEDs is adopted as one set, and the one set of three unit SFEDs are very closely arranged. Each of the unit SFEDs irradiates the corresponding color of RGB, and then the colors are mixed and scanned. Thereby, the color display is possible.

### INDUSTRIAL APPLICABILITY

The SFED according to the present invention can be not only used in a small-size display, but also fabricated in a thin and flat type when applied to a large-area flat display in a multi type, and can be realized in high resolution.

1. A scanning field emission display comprising;
an electron emitter for emitting an electron beam: and
a module for inducing emission of the electron beam from the electron emitter and deflecting the electron beam.

2. The scanning field emission display according to claim 1, wherein the module includes:
an extractor for inducing the emission of the electron beam from the electron emitter;
a control electrode for accelerating the electron beam; and
a deflector for deflecting the electron beam.

3. The scanning field emission display according to claim 1, wherein the module is configured of deflectors.

4. A display comprising:
a multi-scanning field emission display (SFED) having unit SFEDs according to any one of claims 1 to 3 arranged in an n×m matrix; and
a screen having a fluorescent section on which images are realized by an electron beam emitted from the SFEDs.

5. The display according to claim 4, wherein the multi-SFED is configured in a wafer type.

6. A method for controlling electron beams in a multi-scanning field emission display (SFED), in which each unit SFED for emitting electrons to form and control the electron beam is arranged in an N×M matrix, the method comprising the steps of:
selectively controlling an individual electron emitter and an individual electron lens according to one selected from:
a type of applying a single voltage to all apertures through which the electrons of the unit SFED part pass or all electron emitters (first type),
a type of applying a voltage to each unit SFED (aperture or electron emitter) (second type),
a type of applying the same voltage to each same-directional (-coordinate) electrode per unit SFED (third type), and
a type of applying a voltage to each unit SFED and electrode (direction or coordinate) (fourth type);
applying a voltage to the individual electron emitter and an individual extractor of the lens according to the first or second type to extract emission of the electrons from the electron emitter in order to induce emission and electron current; and
applying a voltage according to the third or fourth type to deflect the electron beams.

7. The method according to claim 6, further comprising the step of focusing.

8. The method according to claim 6 or 7, wherein the extracting and deflecting steps are simultaneously performed in one step, or simultaneously performed including both the deflecting step and the focusing step.

9. The method according to any one of claims 6 to 8, wherein the voltage is applied to a lens layer having a predetermined shape according to the first type on the deflecting step, before the deflecting step, or on and before the deflecting step in order to specify shapes of the electron beams in predetermined shapes.

10. The method according to any one of claims 6 to 9, wherein a beam blanker layer is controlled according to the third or fourth type in order to intercept the electron beams before the deflecting step of the multi-SFED.
